(19) United States
(12) Patent Application Publication
(10) Pub. No.: US 2007/0296246 A1
(43) Pub. Date: Dec. 27, 2007

(54) Combination folding utility / tent trailer

(76) Inventor: Gordon Roseborough, St-Lazare (CA)

Correspondence Address: GREER, BURNS & CRAIN, 300 S WACKER DR, 25TH FLOOR, CHICAGO, IL, 60606, US

(21) Appl. No.: 11/811,533

(22) Filed: Jun. 11, 2007

(30) Foreign Application Priority Data
Jun. 12, 2006 (CA) 2,550,228

(51) Int. Cl. B60R 15/00

(52) U.S. Cl. 296/159; 296/173

(57) ABSTRACT

A tent is disclosed for use in connection with a utility trailer having a flat rectangular platform. The tent comprises a frame and a covering for the frame. The frame comprises frame members adapted for detachable connection to the platform.

The present invention relates to the field of utility trailers, and provides a kit for converting a utility trailer into a tent trailer. The present invention also provides a folding trailer.

Conventionally, utility trailers comprise a single platform, supported by one or two axles. The platform is usually provided with an aperture know as a stake pocket in each corner. The function of the stake pocket is to permit side walls or corner posts to be quickly and easily mounted on the trailer.

Tent trailers, on the other hand, are designed for the sole purpose of folding out into relatively spacious tents, and have little or no cargo carrying capability.

The object of the present invention is to provide a tent kit mountable onto a utility trailer, for example, into the stake pockets of utility trailers, so that a tent having a floor size of the flat bed of the trailer can quickly be assembled using a standard sized trailer instead of a specialized pop-up tent trailer.

The applicant is not aware of any other convertable utility trailer with a flat bed that can function as the base for a tent. U.S. Patent Publication No. 2003/0173758 shows a utility trailer convertible to a tent, but the mode of conversion is to the form of a conventional pop-up tent trailer, rather than by mounting a tent frame to the bed of the trailer.

The present invention also provides a folding utility trailer, and a trailer with a utility box or “trunk” located under its deck.

In a broad aspect, then, the present invention relates to a tent for use in connection with a utility trailer having a flat rectangular platform, said tent comprising a frame and a covering for the frame, said frame comprising frame members adapted for detachable connection to said platform.

In drawings that show the present invention by way of example:

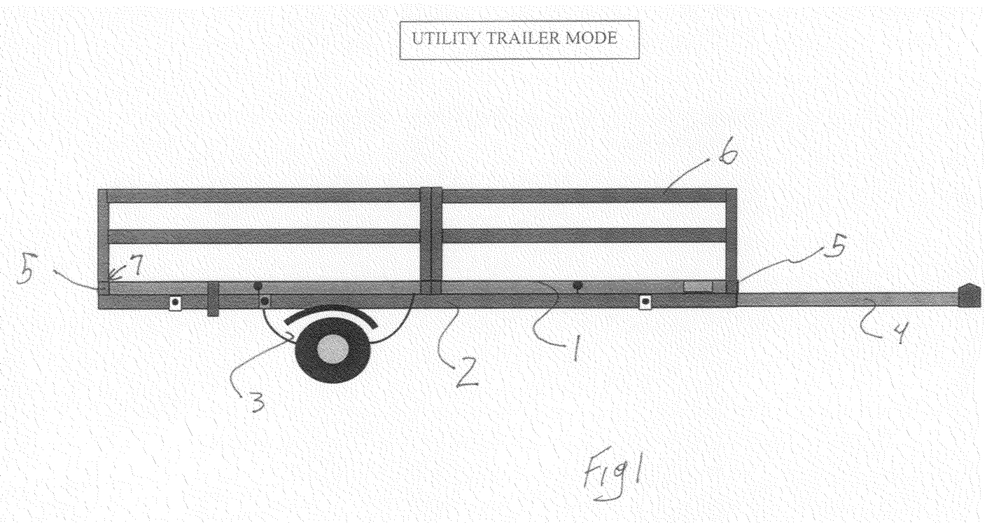

FIG. 1 is a side view of a utility trailer;

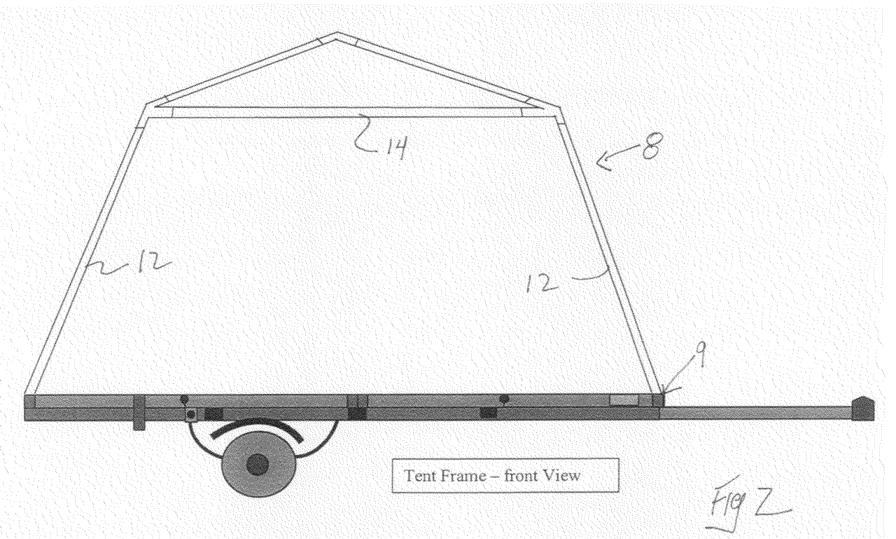

FIG. 2 is a side view of the utility trailer of FIG. 1 with a tent according to the first embodiment of the present invention affixed thereto;

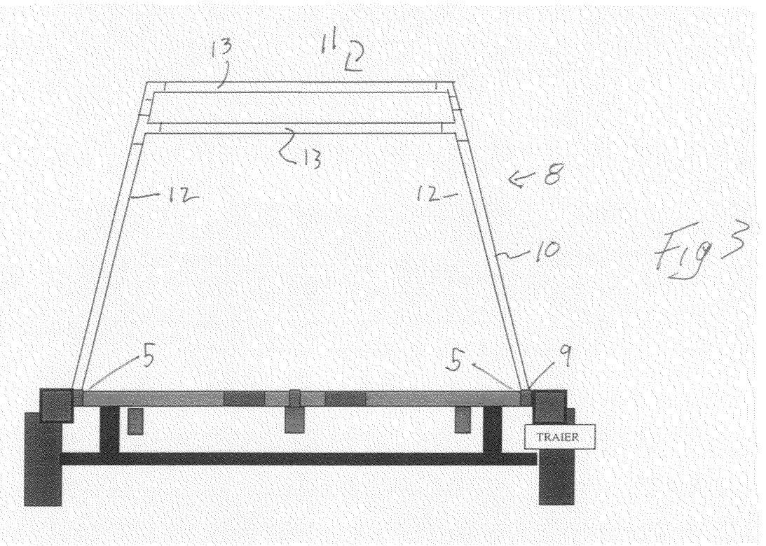

FIG. 3 is an end view of the trailer and tent shown in FIG. 2;

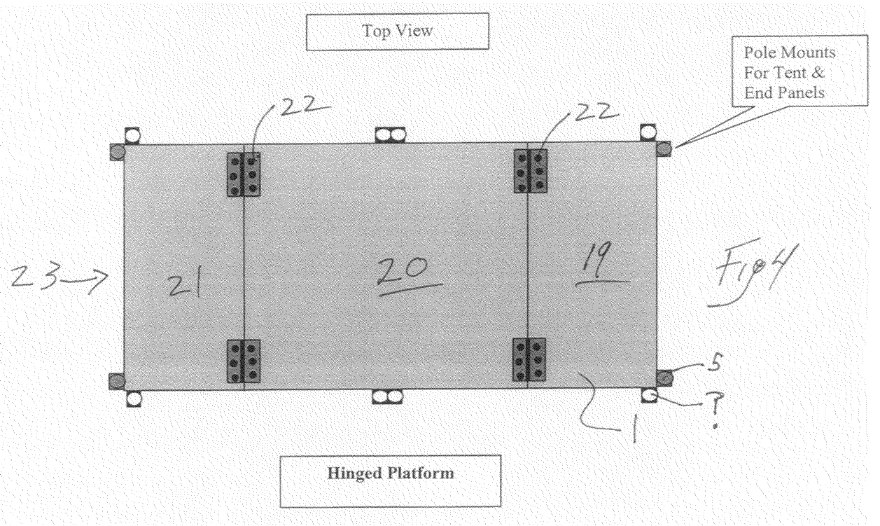

FIG. 4 is a top view of a trailer platform suitable for use with a tent according to the present invention;

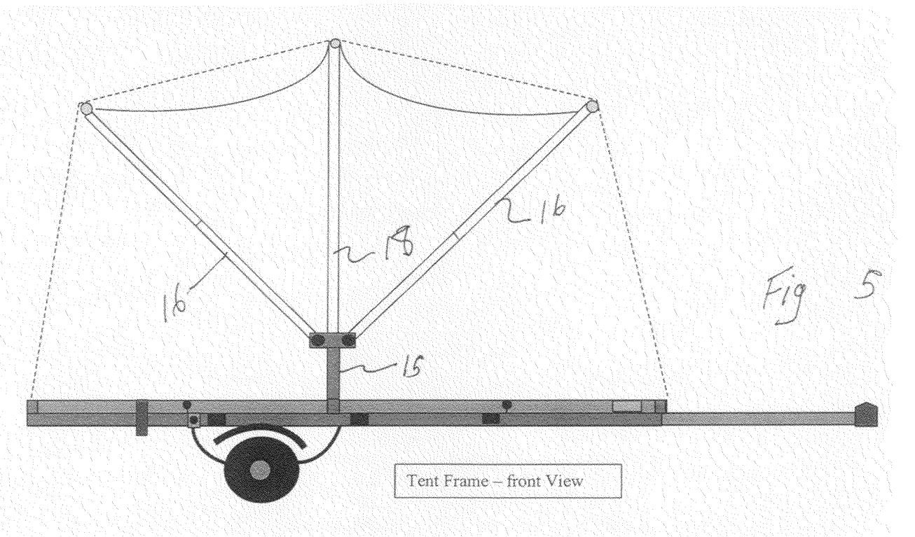

FIG. 5 is a side view of a tent frame according to a second embodiment of the present invention, mounted on a trailer, and erected;

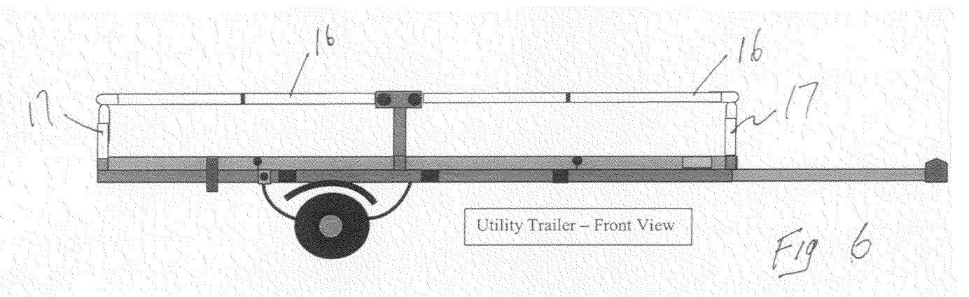

FIG. 6 is a side view of a trailer, with the tent frame shown in FIG. 5 mounted thereto, in a collapsed position;

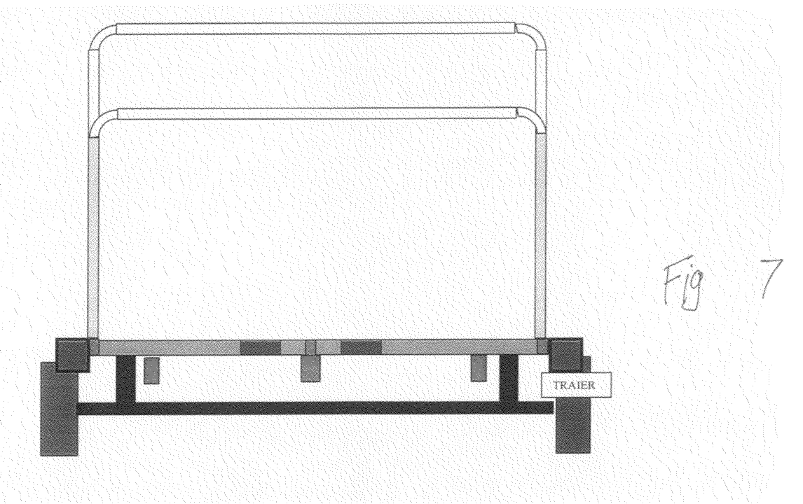

FIG. 7 is an end view of the trailer of FIG. 5 with an erected frame;

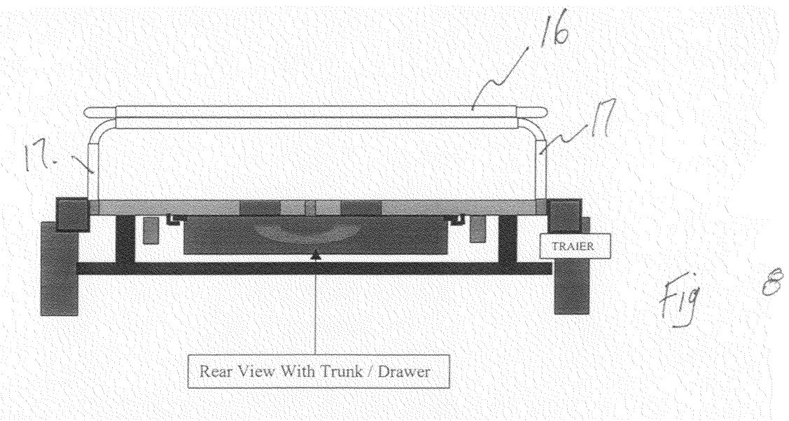

FIG. 8 is an end view of the trailer of FIG. 6 with a collapsed tent frame;

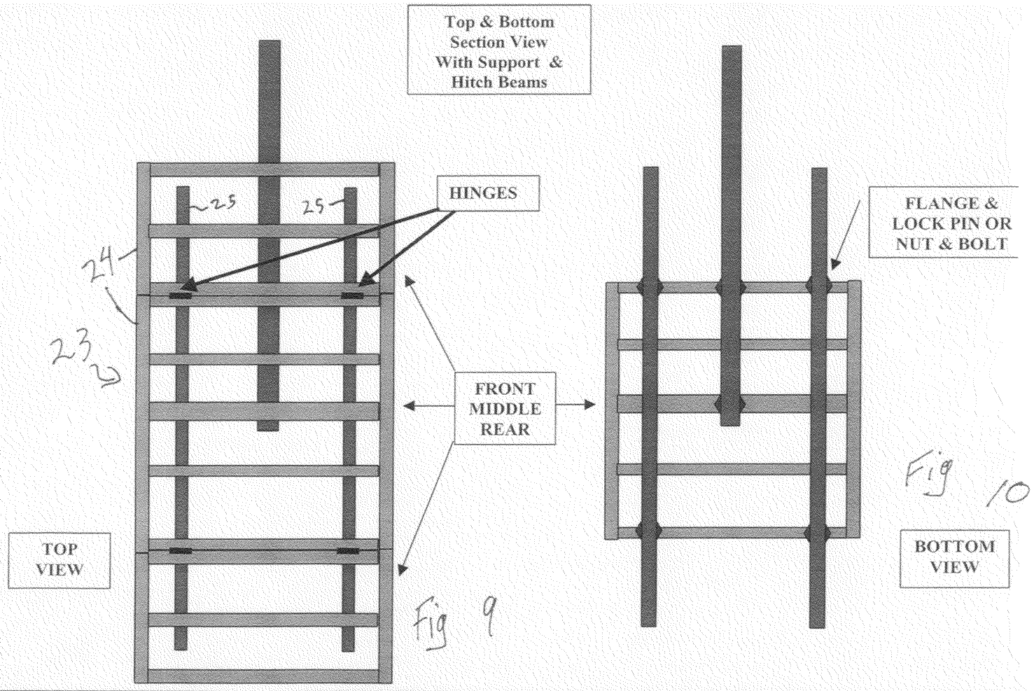

FIG. 9 is a top view of the folding trailer of the present invention, with the platform surface removed;

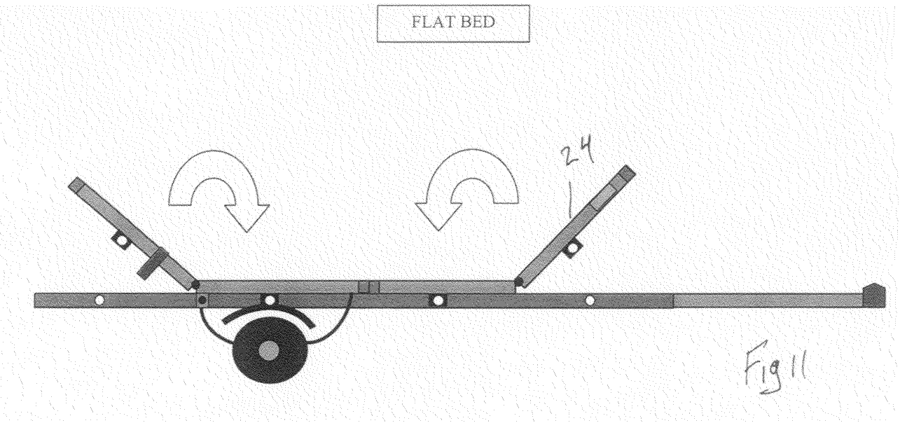

FIG. 10 is an underside view of the folding trailer of the present invention, with the platform surface removed, and the frame folded;

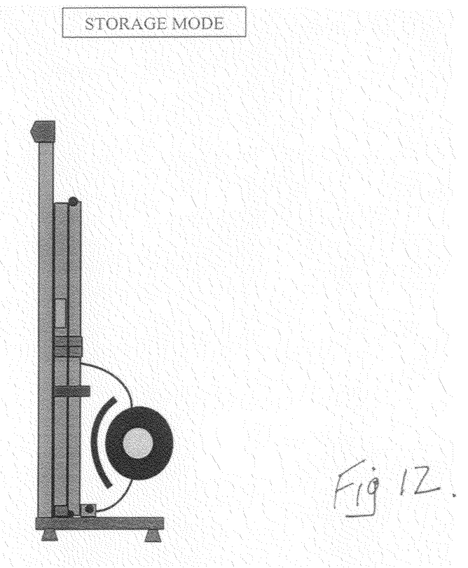

FIG. 11 is a side view of the folding trailer of the present invention, partly folded; and,

FIG. 12 is a side view of the trailer of the present invention fully folded.

Referring to FIG. 1, a utility trailer, which can be a conventional utility trailer, but can be a folding bed trailer as provided by the present invention, has a standard sized platform or bed 1, supported by a frame or chassis 2, that is mounted on an axle assembly. A hitch bar 4 extends from one end of the frame, for attachment to the trailer hitch of a car or truck.

Appropriate lights, reflectors and the like are provided.

In each corner of the trailer platform 2, as shown in FIG. 1 and in FIG. 4, stake pockets 5 are provided. These are, basically, hollow metal cylinders with open upper ends and closed lower ends welded or otherwise formed at each corner. As shown in FIG. 1, side panels (or end panels) may be mounted in the stake pockets. To this end, conventional side panels 6 will be provided with downwardly extending posts 7 alignable with the stake pockets at their ends. Appropriate fastening means, such as pins (not shown) insertable in alignable apertures in the pockets 5 and posts 7 may be provided to securely attach side or end panels to the trailer.

As shown in FIGS. 2 and 3, the present invention takes advantage of the standard sizing of utility trailer platforms, and the provision of stake pockets in the corners of utility trailer platforms, and provides a tent with a frame structure 8 that includes a downwardly extending post 9 in each corner. Accordingly, the tent frame can be quickly assembled onto the platform of a utility trailer.

Referring to FIG. 3, the tent frame structure 8 includes at least four generally upright frame members 10, each of which has a post portion 9 extending from its lowermost extremity. The posts are insertable in the pre-existing stake pockets 5 provided in the corners of a utility trailer platform.

In the event the utility trailer platform available to an individual is of the correct size, but does not have stake pockets, these are easily attachable by welding or other means, to the corners of the platform, and besides rendering the trailer suitable for use with the tent frame provided by the present invention, will generally increase the utility of the trailer, as it will then be possible to easily install side panels, corner posts, or other attachments.

The actual shape of the tent frame may be, as shown in the drawings, roughly trapezoidal, i.e. having side and end panels that are supported on frame members that incline inwardly. Moreover, as shown in FIG. 3, arch structures 11 may be provided at each end of the tent frame. Each arch comprises a pair of uprights 12 that are provided with posts insertable in a stake pocket of the trailer platform. The uprights are connected at their upper extremities by transversely extending members 13. In the illustrated embodiment, a closely spaced pair of transverse members 13 are provided, but only one may be used, if it is sufficiently strong. An arch structure may be provided at each end of a trailer, with lengthwise-extending members 14 connecting together the upper corners thereof. (See FIG. 2)

Alternatively, the frame may consist of four upright members, angulated at their upper extremity and meeting above the mid-point of the trailer platform.

It will be understood, then, that any desired frame structure is possible, depending on the shape and size of the tent intended to be constructed.

A second embodiment of the present invention, showing a particularly favourable frame arrangement, is shown in FIGS. 5, 6, 7 and 8. In the tent shown in those figures, the frame structure is centred around a post on each side of the trailer. The post is T-shaped, and two U-shaped frame members 16 are hinged to the T-shaped posts, one U-shaped frame member 16 extending to the front of the trailer, and one extending to the rear of the trailer. As shown in FIGS. 6 and 8, the U-shaped frame members in a collapsed condition rest on front and rear end frames 17 which may be inserted into the stake pockets of the trailer. The U-shaped members may be pivoted upwardly, as shown in FIGS. 5 and 7, to serve as the principle tent frames. In their upper position, the U-shaped members 16 may be held in place by any known means such as pins, detents, or other means as will be obvious to one skilled in the art.

A central upright U-shaped frame member 18, extending upwardly from the T-shaped posts 16 is preferably provided, to complete the frame structure of the tent. The upright frame member 18 may be carried separately, for instance in a “trunk” or storage box under the trailer platform, as shown in FIG. 8, or it may be assembled from the components of end frames 17. If it is assembled from end frames 17, then it will be desirable that end frames 17 are constructed from telescopic sections.

In order to assemble the tent frame of FIGS. 5 to 8, then, one disconnects U-shaped frame members 16 from end frame members 17, and lifts U-shaped frame members 16 to an inclined position. U-shaped frame members are then locked in place. Upright frame member 18 is then either accessed or assembled from end frame members 17, and inserted into the hollow tubular central posts of T-shaped posts 15. A fabric tent is then installed over the frame.

As noted previously, the present invention also provides a folding trailer. As shown in FIG. 4, the platform 23 of the utility trailer of the present invention is divided into front 19, middle 20 and end 21 sections, connected together by hinges 22. Referring to FIGS. 9 and 10, the platform comprises a framework 24 mounted on left and right longitudinal rails 25 by means of U-shaped brackets extending from the undersurface of the frame, into which rails 25 are locked by means of pins and/or nuts and bolts. The axle structure, not shown in FIGS. 9 and 10, is connected directly to the central part of the frame.

It will be seen, then, that the left and right rails can be removed easily, by unfastening same from the U-shaped brackets. The central rail 15, including a trailer hitch attachment, is also connected by U-shaped brackets to the central portion of the frame.

To disassemble and fold the trailer for storage, the left and right rails are removed and stored. The central rail is removed, and either stored, or as shown in FIG. 12, stacked with the central part of the frame. As shown in FIG. 11, the frame is folded in on itself, and then stacked as shown in FIG. 12, on a stand, platform or the like.

The covering of the frame structure for either of the two described embodiments is an obvious matter of choice for one skilled in the art of tent design. That is, a single layer of canvas, nylon, or other material may suffice. However, more elaborate two-layer tent designs, or designs incorporating rain flys, screens, ventilation, or other features are all within the spirit of the present invention, as long as they incorporate a frame that interconnects to the platform of a utility trailer.

Furthermore, it will be understood that while the preferred embodiment of tent frame members insertable in stake pockets has been described, the tent frame may be connectable to the trailer platform by any other obvious means, such as clips engaging the side edges of the platform or the corners of the platform.

The tent frame may be made of any desired and suitable material, such as aluminum, steel, wood, fibreglass, Kevlar, and so on.

In order to stabilize the trailer against tipping, especially if it is not connected to the trailer hitch of a car, it is desirable to fit a solid object like a block or jack at each end of the level trailer platform during use.

As can be seen in FIG. 4, the present invention also provides a folding utility trailer platform. (Etc.)

We claim:

1. A tent for use in connection with a utility trailer having a flat rectangular platform, said tent comprising a frame and a covering for the frame, said frame comprising frame members adapted for detachable connection to said platform.

2. A tent as claimed in claim 1, wherein said utility trailer platform is provided with stake pockets in its corners.

3. A tent as claimed in claim 2, wherein each said stake pocket comprises a hollow tubular element with at least an opening at its upwardly facing end.

4. A tent as claimed in claim 3, wherein the frame members of said tent are adapted for insertion in said stake pockets.

5. A tent as claimed in claim 3, wherein said tent frame includes a plurality of poles, each of which are provided, at their lower ends, with posts insertable in said stake pockets.
